(19) United States
(12) Patent Application Publication
(10) Pub. No.: US 2026/0040186 A1
(43) Pub. Date: Feb. 5, 2026

(54) APPARATUS, METHOD AND COMPUTER PROGRAM

(71) Applicant: Nokia Technologies Oy, Espoo (FI)

(72) Inventors: Vinh VAN PHAN, Oulu (FI); Ling YU, Espoo (FI); Faranaz SABOURI-SICHANI, Aalborg (DK); György Tamás WOLFNER, Budapest (HU); Mohamed Amin NASSAR, Munich (DE); Hannu Petri HIETALAHTI, Oulu (FI)

(21) Appl. No.: 18/994,826

(22) PCT Filed: Aug. 8, 2023
(86) PCT No.: PCT/EP2023/071924

§ 371 Date: Jan. 15, 2025

(30) Foreign Application Priority Data
Aug. 9, 2022 (GB) 2211631.3

(51) Int. Cl. H04W 40/22; H04W 40/24; H04W 88/04

(52) U.S. Cl. CPC H04W 40/22; H04W 40/246; H04W 88/04

(57) ABSTRACT

There is provided an apparatus, at a user equipment, comprising means for determining, based on a trigger, to select or reselect a further user equipment to act as a relay node between the first user equipment and a second user equipment, wherein the first user equipment and the second user are in communication, determining a source of the trigger, based on the determined source, determining to provide a request from the first user equipment to the second user equipment for at least one of the following: coordinated discovery of user equipment candidates for the further user equipment, selection or reselection of the further user equipment among the user equipment candidates and providing the request from the first user equipment to the second user equipment.

### FIELD

Various example embodiments described herein relate to methods, apparatuses, systems and computer programs and in particular but not exclusively to sidelink (SL) user equipment-to-user equipment (U2U) relay (re)selection for support of service continuity (SC).

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first example embodiment there is provided an apparatus, at a first user equipment, comprising means for determining, based on a trigger, to select or reselect a further user equipment to act as a relay node between the first user equipment and a second user equipment, wherein the first user equipment and the second user are in communication, determining a source of the trigger, based on the determined source, determining to provide a request from the first user equipment to the second user equipment for at least one of the following: coordinated discovery of user equipment candidates for the further user equipment, selection or reselection of the further user equipment among the user equipment candidates and providing the request from the first user equipment to the second user equipment.

The source of the trigger may be the first user equipment.

The first user equipment and the second user equipment may be in communication via a third user equipment acting as a relay node and the source of the trigger may be the third user equipment acting as the relay node.

The source of the trigger may be the second user equipment, and the apparatus may comprise means for receiving information from the second user equipment and determining to provide the request for at least one of the following: coordinated discovery, selection or reselection further based on the information.

The means for determining may comprises means for determining whether the information comprises a list of user equipment candidates for the further user equipment, whether the number of user equipment candidates in the list is below a threshold, whether the list of user equipment candidates comprises a user equipment candidate on a list of user equipment candidates at the first user equipment or whether the information comprises an indication that the second user equipment is performing a coordinated relay discovery procedure.

The request may comprise at least one of the following: a list of user equipment candidates for the further user equipment, an indication of whether coordinated discovery at the second user equipment is requested or an indication that the first user equipment is performing the coordinated discovery procedure.

The apparatus may comprise means for receiving an indication from the second user equipment in response to the request, wherein the indication comprises at least one of the following: an identity of the further user equipment, an indication that selection or reselection is not currently possible based on the list of user equipment candidates, an indication that the second user equipment is performing the coordinated discovery procedure or a further list of user equipment candidates for the further user equipment.

The apparatus may comprise means for, in response to receiving the indication from the second user equipment that the second user equipment is performing the coordinated discovery procedure, transmitting a discovery solicitation to user equipment candidates from the first user equipment comprising an indication indicating to user equipment candidates to monitor a discovery message from the second user equipment.

In a second example embodiment there is provided an apparatus, at a second user equipment, comprising means for receiving a request from a first user equipment at the second user equipment for at least one of the following: coordinated discovery of user equipment candidates for a further user equipment, selection or reselection of the further user equipment among the user equipment candidates to act as a relay node between the first user equipment and the second user equipment, wherein the first user equipment and second user equipment are in communication.

The apparatus may comprise means for providing a trigger from the second user equipment to the first user equipment to select or reselect the further user equipment to act as the relay node between the first user equipment and the second user equipment.

The request may comprise a list of user equipment candidates for the further user equipment, an indication of whether coordinated discovery at the second user equipment is requested or an indication that the first user equipment is performing a coordinated discovery procedure.

The apparatus may comprise means for determining, based on the request, to perform a coordinated discovery procedure at the second user equipment for the further user equipment; performing the coordinated discovery procedure and providing an indication indicating that the second user equipment is performing the coordinated discovery procedure to the first user equipment.

Means for performing the coordinated discovery procedure may comprise means for providing a broadcast discovery announcement or a groupcast discovery response to user equipment candidates, comprising layer-2 identifiers of the first user equipment and the second user equipment.

The apparatus may comprise means for determining, based on the request to perform a relay selection or relay reselection procedure at the second user equipment, performing the relay selection or reselection procedure at the second user equipment and providing an indication from the second user equipment to the first user equipment of an identity of the further user equipment.

The apparatus may comprise means for providing an indication from the second user equipment in response to the request, wherein the indication comprises at least one of the following: an indication that selection or reselection is not currently possible based on the list of user equipment candidates or a further list of user equipment candidates for the further user equipment.

The apparatus may comprise means for, in response to receiving the indication from the first user equipment that the first user equipment is performing the coordinated discovery procedure, transmitting a discovery solicitation to user equipment candidates from the second user equipment comprising an indication indicating to user equipment candidates to monitor a discovery message from the first user equipment.

In a third example embodiment there is provided a method comprising, at a first user equipment, determining, based on a trigger, to select or reselect a further user equipment to act as a relay node between the first user equipment and a second user equipment, wherein the first user equipment and the second user are in communication, determining a source of the trigger, based on the determined source, determining to provide a request from the first user equipment to the second user equipment for at least one of the following: coordinated discovery of user equipment candidates for the further user equipment, selection or reselection of the further user equipment among the user equipment candidates and providing the request from the first user equipment to the second user equipment.

The source of the trigger may be the first user equipment.

The first user equipment and the second user equipment may be in communication via a third user equipment acting as a relay node and the source of the trigger may be the third user equipment acting as the relay node.

The source of the trigger may be the second user equipment, and the method may comprise receiving information from the second user equipment and determining to provide the request for at least one of the following: coordinated discovery, selection or reselection further based on the information.

Determining may comprises determining whether the information comprises a list of user equipment candidates for the further user equipment, whether the number of user equipment candidates in the list is below a threshold, whether the list of user equipment candidates comprises a user equipment candidate on a list of user equipment candidates at the first user equipment or whether the information comprises an indication that the second user equipment is performing a coordinated relay discovery procedure.

The request may comprise at least one of the following: a list of user equipment candidates for the further user equipment, an indication of whether coordinated discovery at the second user equipment is requested or an indication that the first user equipment is performing the coordinated discovery procedure.

The method may comprise receiving an indication from the second user equipment in response to the request, wherein the indication comprises at least one of the following: an identity of the further user equipment, an indication that selection or reselection is not currently possible based on the list of user equipment candidates, an indication that the second user equipment is performing the coordinated discovery procedure or a further list of user equipment candidates for the further user equipment.

The method may comprise, in response to receiving the indication from the second user equipment that the second user equipment is performing the coordinated discovery procedure, transmitting a discovery solicitation to user equipment candidates from the first user equipment comprising an indication indicating to user equipment candidates to monitor a discovery message from the second user equipment.

In a fourth example embodiment there is provided a method comprising, at a second user equipment, receiving a request from a first user equipment at the second user equipment for at least one of the following: coordinated discovery of user equipment candidates for a further user equipment, selection or reselection of the further user equipment among the user equipment candidates to act as a relay node between the first user equipment and the second user equipment, wherein the first user equipment and second user equipment are in communication.

The method may comprise providing a trigger from the second user equipment to the first user equipment to select or reselect the further user equipment to act as the relay node between the first user equipment and the second user equipment.

The request may comprise a list of user equipment candidates for the further user equipment, an indication of whether coordinated discovery at the second user equipment is requested or an indication that the first user equipment is performing a coordinated discovery procedure.

The method may comprise determining, based on the request, to perform a coordinated discovery procedure at the second user equipment for the further user equipment; performing the coordinated discovery procedure and providing an indication indicating that the second user equipment is performing the coordinated discovery procedure to the first user equipment.

Performing the coordinated discovery procedure may comprise providing a broadcast discovery announcement or a groupcast discovery response to user equipment candidates, comprising layer-2 identifiers of the first user equipment and the second user equipment.

The method may comprise determining, based on the request to perform a relay selection or relay reselection procedure at the second user equipment, performing the relay selection or reselection procedure at the second user equipment and providing an indication from the second user equipment to the first user equipment of an identity of the further user equipment.

The method may comprise providing an indication from the second user equipment in response to the request, wherein the indication comprises at least one of the following: an indication that selection or reselection is not currently possible based on the list of user equipment candidates or a further list of user equipment candidates for the further user equipment.

The method may comprise, in response to receiving the indication from the first user equipment that the first user equipment is performing the coordinated discovery procedure, transmitting a discovery solicitation to user equipment candidates from the second user equipment comprising an indication indicating to user equipment candidates to monitor a discovery message from the first user equipment.

In a fifth example embodiment there is provided an apparatus comprising: at least one processor and at least one memory storing instructions that, when executed by the at least one processor, cause the apparatus at least to, at a first user equipment, determine, based on a trigger, to select or reselect a further user equipment to act as a relay node between the first user equipment and a second user equipment, wherein the first user equipment and the second user are in communication, determine a source of the trigger, based on the determined source, determine to provide a request from the first user equipment to the second user equipment for at least one of the following: coordinated discovery of user equipment candidates for the further user equipment, selection or reselection of the further user equipment among the user equipment candidates and provide the request from the first user equipment to the second user equipment.

The source of the trigger may be the first user equipment.

The first user equipment and the second user equipment may be in communication via a third user equipment acting as a relay node and the source of the trigger may be the third user equipment acting as the relay node.

The source of the trigger may be the second user equipment, and the apparatus may be caused to receive information from the second user equipment and determining to provide the request for at least one of the following: coordinated discovery, selection or reselection further based on the information.

The apparatus may be caused to determine whether the information comprises a list of user equipment candidates for the further user equipment, whether the number of user equipment candidates in the list is below a threshold, whether the list of user equipment candidates comprises a user equipment candidate on a list of user equipment candidates at the first user equipment or whether the information comprises an indication that the second user equipment is performing a coordinated relay discovery procedure.

The request may comprise at least one of the following: a list of user equipment candidates for the further user equipment, an indication of whether coordinated discovery at the second user equipment is requested or an indication that the first user equipment is performing the coordinated discovery procedure.

The apparatus may be caused to receive an indication from the second user equipment in response to the request, wherein the indication comprises at least one of the following: an identity of the further user equipment, an indication that selection or reselection is not currently possible based on the list of user equipment candidates, an indication that the second user equipment is performing the coordinated discovery procedure or a further list of user equipment candidates for the further user equipment.

The apparatus may be caused to, in response to receiving the indication from the second user equipment that the second user equipment is performing the coordinated discovery procedure, transmit a discovery solicitation to user equipment candidates from the first user equipment comprising an indication indicating to user equipment candidates to monitor a discovery message from the second user equipment.

In a sixth example embodiment there is provided an apparatus comprising: at least one processor and at least one memory storing instructions that, when executed by the at least one processor, cause the apparatus at least to, at a second user equipment, receive a request from a first user equipment at the second user equipment for at least one of the following: coordinated discovery of user equipment candidates for a further user equipment, selection or reselection of the further user equipment among the user equipment candidates to act as a relay node between the first user equipment and the second user equipment, wherein the first user equipment and second user equipment are in communication.

The apparatus may be caused to provide a trigger from the second user equipment to the first user equipment to select or reselect the further user equipment to act as the relay node between the first user equipment and the second user equipment.

The request may comprise a list of user equipment candidates for the further user equipment, an indication of whether coordinated discovery at the second user equipment is requested or an indication that the first user equipment is performing a coordinated discovery procedure.

The apparatus may be caused to determine, based on the request, to perform a coordinated discovery procedure at the second user equipment for the further user equipment; perform the coordinated discovery procedure and provide an indication indicating that the second user equipment is performing the coordinated discovery procedure to the first user equipment.

The apparatus may be caused to provide a broadcast discovery announcement or a groupcast discovery response to user equipment candidates, comprising layer-2 identifiers of the first user equipment and the second user equipment.

The apparatus may be caused to determine, based on the request to perform a relay selection or relay reselection procedure at the second user equipment, performing the relay selection or reselection procedure at the second user equipment and providing an indication from the second user equipment to the first user equipment of an identity of the further user equipment.

The apparatus may be caused to provide an indication from the second user equipment in response to the request, wherein the indication comprises at least one of the following: an indication that selection or reselection is not currently possible based on the list of user equipment candidates or a further list of user equipment candidates for the further user equipment.

The apparatus may be caused to, in response to receiving the indication from the first user equipment that the first user equipment is performing the coordinated discovery procedure, transmit a discovery solicitation to user equipment candidates from the second user equipment comprising an indication indicating to user equipment candidates to monitor a discovery message from the first user equipment.

In a seventh example embodiment there is provided a computer readable medium comprising instructions which, when executed by an apparatus, cause the apparatus to perform at least the following, at a first user equipment, determining, based on a trigger, to select or reselect a further user equipment to act as a relay node between the first user equipment and a second user equipment, wherein the first user equipment and the second user are in communication; determining a source of the trigger, based on the determined source, determining to provide a request from the first user equipment to the second user equipment for at least one of the following: coordinated discovery of user equipment candidates for the further user equipment, selection or reselection of the further user equipment among the user equipment candidates; and providing the request from the first user equipment to the second user equipment.

The source of the trigger may be the first user equipment.

The first user equipment and the second user equipment may be in communication via a third user equipment acting as a relay node and the source of the trigger may be the third user equipment acting as the relay node.

The source of the trigger may be the second user equipment, and the apparatus may be caused to perform receiving information from the second user equipment and determining to provide the request for at least one of the following: coordinated discovery, selection or reselection further based on the information.

The apparatus may be caused to perform determining whether the information comprises a list of user equipment candidates for the further user equipment, whether the number of user equipment candidates in the list is below a threshold, whether the list of user equipment candidates comprises a user equipment candidate on a list of user equipment candidates at the first user equipment or whether the information comprises an indication that the second user equipment is performing a coordinated relay discovery procedure.

The request may comprise at least one of the following: a list of user equipment candidates for the further user equipment, an indication of whether coordinated discovery at the second user equipment is requested or an indication that the first user equipment is performing the coordinated discovery procedure.

The apparatus may be caused to perform receiving an indication from the second user equipment in response to the request, wherein the indication comprises at least one of the following: an identity of the further user equipment, an indication that selection or reselection is not currently possible based on the list of user equipment candidates, an indication that the second user equipment is performing the coordinated discovery procedure or a further list of user equipment candidates for the further user equipment.

The apparatus may be caused to perform, in response to receiving the indication from the second user equipment that the second user equipment is performing the coordinated discovery procedure, transmitting a discovery solicitation to user equipment candidates from the first user equipment comprising an indication indicating to user equipment candidates to monitor a discovery message from the second user equipment.

In an eighth example embodiment there is provided a computer readable medium comprising instructions which, when executed by an apparatus, cause the apparatus to perform at least the following, at a second user equipment, receiving a request from a first user equipment at the second user equipment for at least one of the following: coordinated discovery of user equipment candidates for a further user equipment, selection or reselection of the further user equipment among the user equipment candidates to act as a relay node between the first user equipment and the second user equipment, wherein the first user equipment and second user equipment are in communication.

The apparatus may be caused to perform providing a trigger from the second user equipment to the first user equipment to select or reselect the further user equipment to act as the relay node between the first user equipment and the second user equipment.

The request may comprise a list of user equipment candidates for the further user equipment, an indication of whether coordinated discovery at the second user equipment is requested or an indication that the first user equipment is performing a coordinated discovery procedure.

The apparatus may be caused to perform determining, based on the request, to perform a coordinated discovery procedure at the second user equipment for the further user equipment;

performing the coordinated discovery procedure and providing an indication indicating that the second user equipment is performing the coordinated discovery procedure to the first user equipment.

The apparatus may be caused to perform providing a broadcast discovery announcement or a groupcast discovery response to user equipment candidates, comprising layer-2 identifiers of the first user equipment and the second user equipment.

The apparatus may be caused to perform determining, based on the request to perform a relay selection or relay reselection procedure at the second user equipment, performing the relay selection or reselection procedure at the second user equipment and providing an indication from the second user equipment to the first user equipment of an identity of the further user equipment.

The apparatus may be caused to perform providing an indication from the second user equipment in response to the request, wherein the indication comprises at least one of the following: an indication that selection or reselection is not currently possible based on the list of user equipment candidates or a further list of user equipment candidates for the further user equipment.

The apparatus may be caused to perform, in response to receiving the indication from the first user equipment that the first user equipment is performing the coordinated discovery procedure, transmitting a discovery solicitation to user equipment candidates from the second user equipment comprising an indication indicating to user equipment candidates to monitor a discovery message from the first user equipment.

In a ninth example embodiment there is provided a non-transitory computer readable medium comprising program instructions for causing an apparatus to perform at least the method according to the third or fourth example embodiments.

In the above, many different example embodiments have been described. It should be appreciated that further example embodiments may be provided by the combination of any two or more of the example embodiments described above.

### DESCRIPTION OF FIGURES

Example embodiments will now be further described, by way of example only, with reference to the accompanying Figures in which:

FIG. 1 shows a schematic diagram of a 5GS communication system according to an example embodiment;

FIG. 2 shows a schematic diagram of a mobile communication device according to an example embodiment;

FIG. 3 shows a schematic diagram of a control apparatus according to an example embodiment;

FIG. 4 shows a schematic diagram of a U2U relay scenario according to an example embodiment;

FIG. 5 shows an signalling flow for U2U relay (re)selection according to an example embodiment;

FIG. 6 shows a signalling flow for SL discovery with U2U relay according to an example embodiment;

FIG. 7 shows a flowchart of a method according to an example embodiment;

FIG. 8 shows a flowchart of a method according to an example embodiment;

FIG. 9 shows a signalling flow according to an example embodiment;

FIG. 10 shows a signalling flow according to an example embodiment.

### DETAILED DESCRIPTION

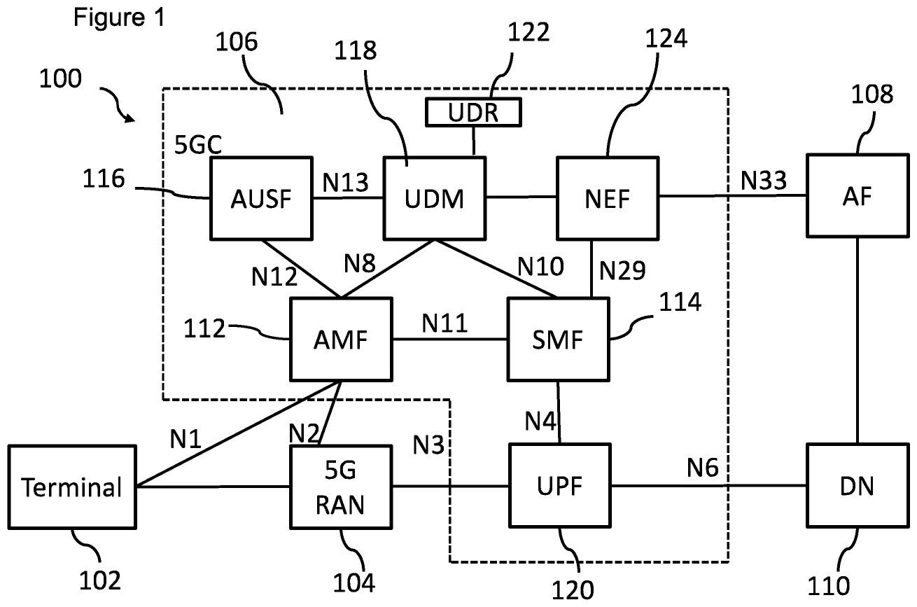

Before explaining in detail the example embodiments, certain principles of a wireless communication system and mobile communication devices are briefly explained with reference to FIGS. 1 to 3 to assist in understanding the technology underlying the described example embodiments.

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. Quality of Service (QoS) levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100 according to an example embodiment. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a UE via the radio access network (RAN). The 5GRAN may comprise one or more gNodeB (GNB) distributed unit functions connected to one or more gNodeB (GNB) centralized unit functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

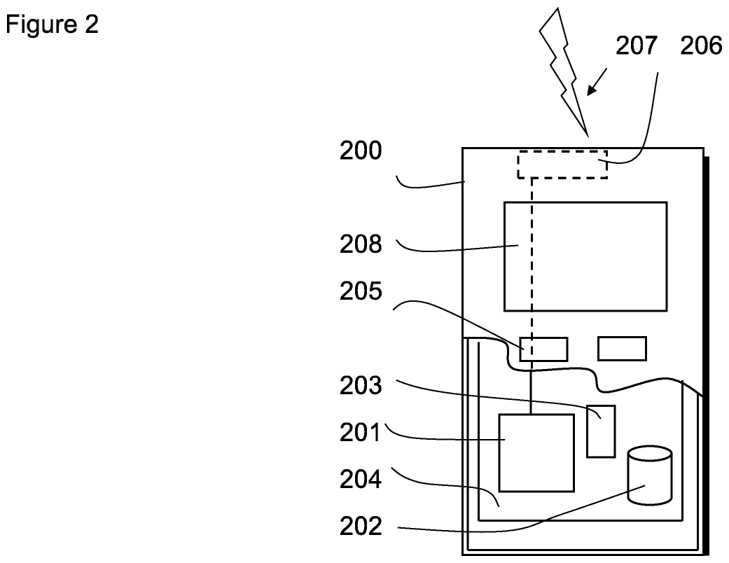

A possible mobile communication device will now be described in more detail with reference to FIG. 2 showing a schematic, partially sectioned view of a communication device 200 according to an example embodiment. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

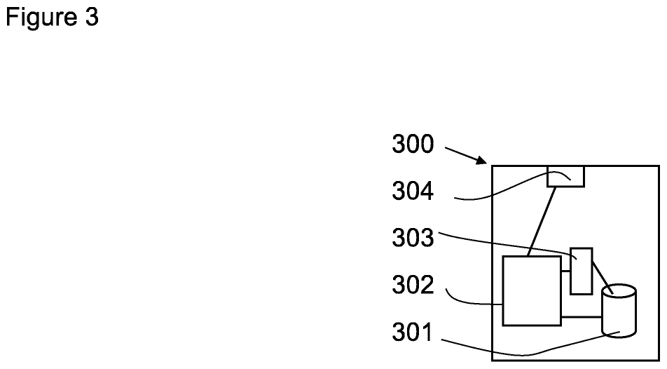

FIG. 3 shows a control apparatus 300 for a communication system according to an example embodiment, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implemented in a single control apparatus or across more than one control apparatus. The control apparatus may be integrated with or external to a node or module of a core network or RAN. In some example embodiments, base stations comprise a separate control apparatus unit or module. In other example embodiments, the control apparatus can be another network element such as a radio network controller or a spectrum controller. In some example embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

The following relates to sidelink (SL) based UE-to-UE (U2U) relays.

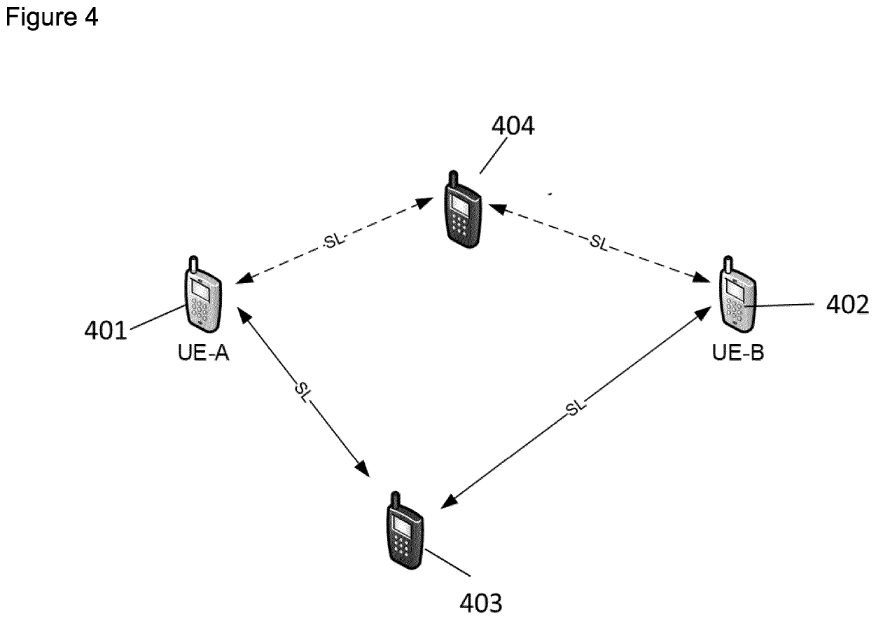

FIG. 4 shows a schematic diagram of a U2U relay scenario according to an example embodiment. In this example scenario, UE-A 401 is a source UE and UE-B 402 is a destination UE. UE-A 401 and UE-B 402 may communicate with each other directly or indirectly over SL via U2U relay UE 403. UE 403 is the current serving U2U relay. UE 404 is a candidate U2U relay UE.

Model A and Model B are two models specified in 3GPP for sidelink discovery in general. Model A: involves one UE announcing “I am here”. Model B: involves one UE asking “who is there” and/or “are you there”.

In general, improvements with respect to speed and/or efficiency in the (re)selection of a new U2U Relay UE2 to support service continuity (SC) between the source UE (e.g., UE-A 401) and destination UE (e.g., UE-B 402) can be beneficial.

How UE-A and UE-B perform U2U relay discovery (RD) and determine U2U relay (re)selection is rather open. For example, potential U2U Relay UEs using Model A may not announce themselves for U2U RD all the time for power-saving and resource-efficiency reasons. Thus, for a robust U2U RD, UE-A 401 and UE-B 402 may need to consider using both Model A and Model B. U2U relay (re)selection may be triggered by any one of the UEs (UE-A 401, UE-B 402, and the serving U2U Relay UE1 403). U2U relay (re)selection is coordinated at least between UE-A 401 and UE-B 402 in order to ensure that the (re)selected U2U Relay UE2 is suitable for both UE-A 401 and UE-B 402. It is not clear which one of the UEs (UE-A 401 or UE-B 402) is in charge of the (re)selection decision and whether and how U2U RD is coordinated between UE-A 401 and UE-B 402, as the (re)selection is targeted for SC.

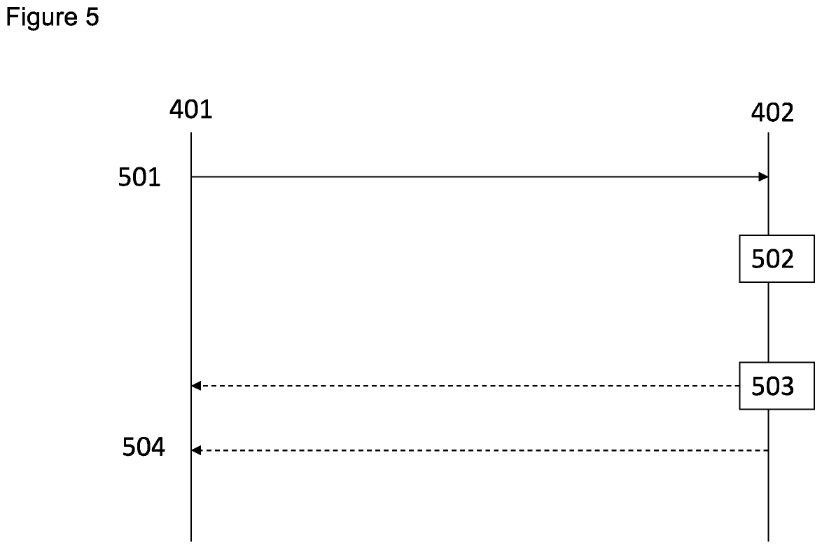

Assuming that UE-A 401 and UE-B 402 have up-to-date information about all U2U Relay UE candidates 403 in their proximity, the U2U relay (re)selection for SC between UE-A 401 and UE-B 402 has the following steps, as shown in FIG. 5

In 501, UE-A 401 sends a U2U Relay Reselection Request to UE-B 402, indicating a list of U2U Relay UE candidates to UE-B 402.

In 502, UE-B 402 determines whether there are common U2U Relay UE candidates between UE-A 401 and UE-B 402.

In 503, if there are common U2U Relay UE candidates, UE-B 402 may (re)select one of them and initiate a SL connection reestablishment with UE-A 401 via the selected one. In addition, UE-B 402 may respond to UE-A 401 indicating the (re)selected U2U Relay UE before SL connection is reestablished over the (re)selected relay UE.

In 504, if there are no common U2U Relay UE candidates, UE-B 402 may respond to UE-A 401 indicating that U2U relay (re)selection is currently not possible.

Since it may be up to UE and application implementation whether U2U Relay UE is using Model A or Model B, or both, for U2U RD and that all the UEs involved in a SL U2U relays based connection may be moving independently, the assumption that UE-A 401 and UE-B 402 have up-to-date information about all U2U Relay UE candidates in their proximity may not be taken for granted but need to be reassured or verified on the fly upon a need of U2U relay (re)selection.

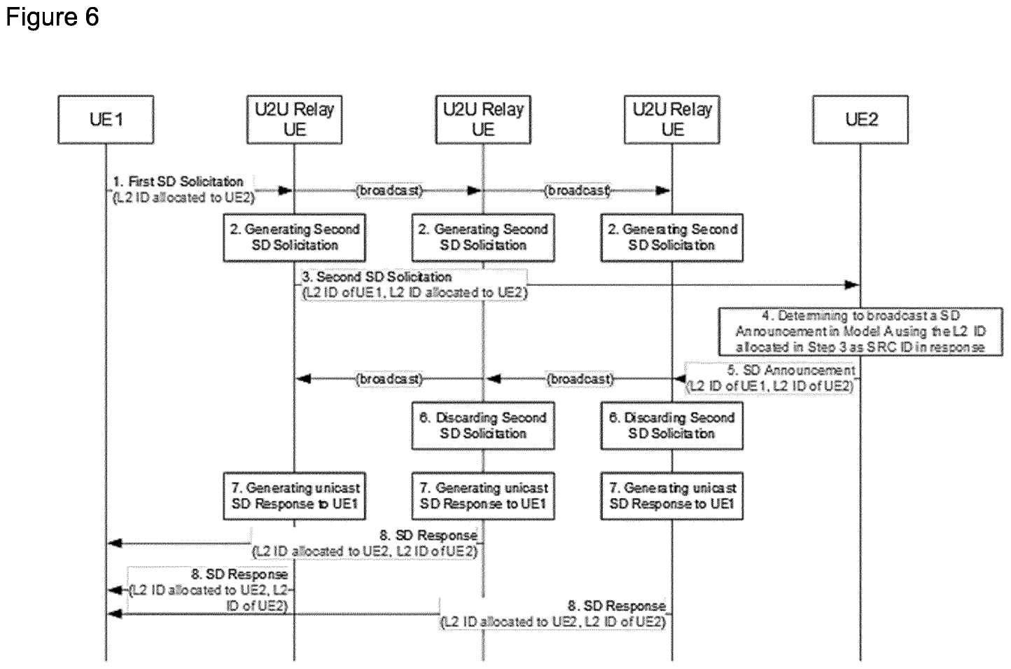

FIG. 6 shows a signalling flow for SL discovery with U2U relay according to an example embodiment, in which access-stratum (AS) assisted sidelink discovery (SD) with SL based U2U Relay is provided for UE1 to discover UE2 as well as U2U Relay UE candidates to reach UE2. However, no particular SC aspects and possible coordination between UE1 and UE2 over an existing SL connection beforehand for U2U relay (re)selection were considered in such a proposal.

The following focuses on coordination between UE-A 401, UE-B 402, and involved U2U Relay UE(s) to enable fast and efficient U2U relay (re)selection for SC between UE-A 401 and UE-B 402.

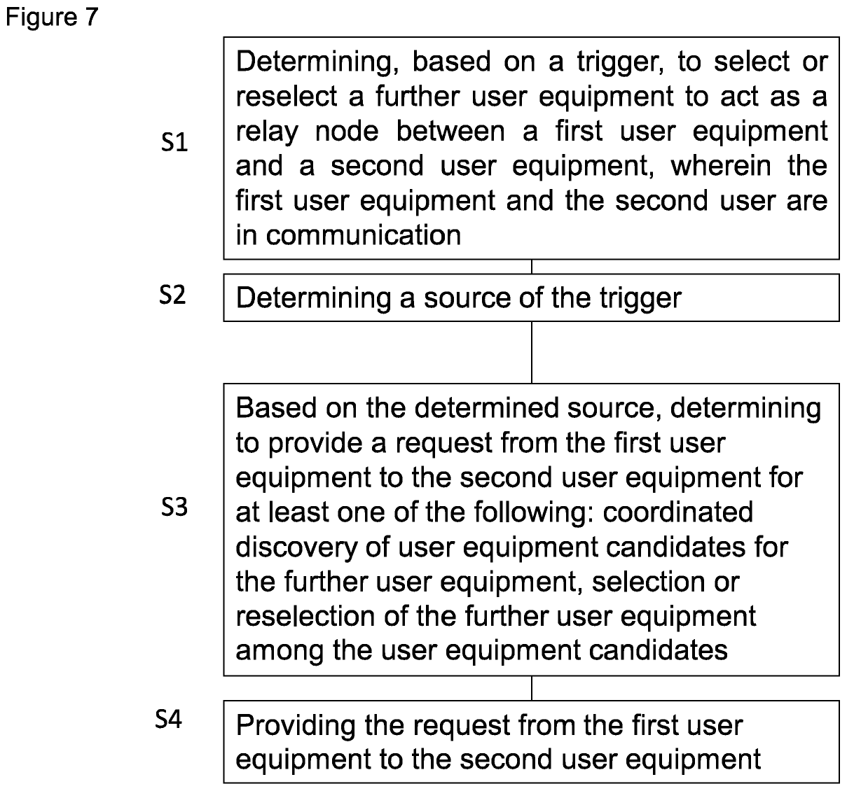

FIG. 7 shows a flowchart of a method according to an example embodiment.

In S1, the method comprises determining, at a first user equipment, based on a trigger, to select or reselect a further user equipment to act as a relay node between the first user equipment and a second user equipment, wherein the first user equipment and the second user are in communication.

In S2, the method comprises determining a source of the trigger.

In S3, the method comprises, based on the determined source, determining to provide a request from the first user equipment to the second user equipment for at least one of the following, coordinated discovery of user equipment candidates for the further user equipment, selection or reselection (in other words, coordinated discovery and/or (re)selection) of the further user equipment among the user equipment candidates.

In S4, the method comprises providing the request from the first user equipment to the second user equipment.

The source of the trigger may be the first user equipment, the second user equipment or a third user equipment acting as a relay node when the first UE and the second UE are in communication via the third user equipment acting as the relay node.

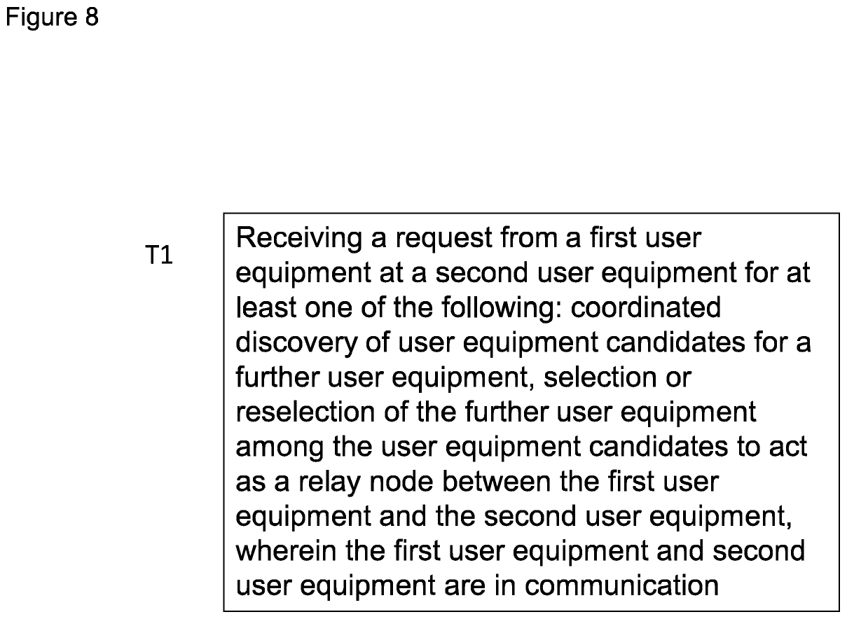

FIG. 8 shows a flowchart of a method according to an example embodiment.

In T1, the method comprises receiving a request from a first user equipment at a second user equipment for at least one of the following: coordinated discovery of user equipment candidates for a further user equipment, selection or reselection of the further user equipment among the user equipment candidates to act as a relay node between the first user equipment and the second user equipment, wherein the first user equipment and second user equipment are in communication.

The method may allow coordination at least between UE-A 401 and UE-B 402 for U2U relay discovery and/or (re)selection for SC. In some of the example embodiments described below, UE-A 401 is assumed to be taking the coordinating role. However, triggers for U2U relay discovery and/or (re)selection may be initiated by either UE-A 401, or UE-B 402, or the current U2U Relay UE1 403 when UE-A 401 and UE-B 402 are currently communicating with each other via U2U Relay UE1 403.

For example, a UE-A 401 may determine a U2U relay (re)selection for SC between UE-A 401 and UE-B 402 is needed (in other words, to select or reselect a further user equipment to act as a relay node between a first UE and a second UE).

The UE-A 401 further determines whether a SL procedure for coordinating U2U relay (re)selection between UE-A 401 and UE-B 402, namely a SL U2U Relay (re)selection request, needs to be initiated or not (e.g., whether to provide a request from the first user equipment to the second user equipment for coordinated discovery and/or (re)selection of the further user equipment). The further determination is based on where the trigger for the U2U relay (re)selection comes from, e.g., which of the first UE, second UE or third UE acting as a relay node, e.g., UE-A 401, UE-B 402, or U2U Relay UE1 403.

In an example embodiment, if the trigger comes from UE-A 401 itself or the current U2U Relay UE1 403 such as upon a SL UE Info received from U2U Relay UE1 403 indicating that U2U Relay UE1 403 is not able to serve UE-A 401 and UE-B 402 and that UE-A 401 and UE-B 402 need to reselect a new U2U Relay UE2 404 within a time limit, UE-A 401 will initiate a SL U2U Relay (re)selection request to UE-B 402.

When the source of the trigger is the second UE, e.g., UE-B 402, the method may comprise receiving information from the second user equipment and determining to provide a request for coordinated relay discovery and/or (re)selection further based on the information. The second UE may provide a list of user equipment candidates for the further user equipment to the first UE in the information.

The determining may comprise determining whether the information comprises a list of user equipment candidates for the further user equipment, whether the number of user equipment candidates in the list is below a threshold, whether the list of user equipment candidates comprises a user equipment candidate on a list of user equipment candidates at the first user equipment or whether the information comprises an indication that the second user equipment is performing a coordinated relay discovery procedure.

For example, the further determination may also be based on whether there are sufficient U2U Relay UE candidates provided by UE-B or not, as follows.

In an example embodiment, if the trigger comes from UE-B such as upon a SL UE Info received from UE-B indicating that SL between UE-B and U2U Relay UE1 becomes inadequate (e.g., SL RSRP between UE-B and U2U Relay UE1 is below a threshold), UE-A 401 may determine whether to initiate a SL U2U Relay (re)selection request based on whether UE-B 402 provides a list of U2U Relay UE candidates to UE-A 401 along with the SL UE Info or not, the number of U2U Relay UE candidates in the list, whether there is a match in U2U Relay UE candidates between the list provided by UE-B 402 and the list maintained at UE-A 401, or whether UE-B 402 provides an indication indicating that UE-B 402 is taking a proactive action for a coordinated U2U RD by: either announcing itself using the current L2 ID of UE-B 402 known to UE-A 401 as SRC ID as well as indicating the current L2 ID of UE-A 401 in the announcement for the coordinated U2U RD using Model A; or groupcasting a U2U RD response using the current L2 ID of UE-A 401 as DST ID and the current L2 ID of UE-B 402 as SRC ID for the coordinated U2U RD using Model B, based on the scheme shown in FIG. 6. An empty list of U2U Relay UE candidates may imply that there are no U2U Relay UE candidates which are announcing themselves to UE-A 401 or UE-B 402 using Model A for possible U2U RD.

UE-A 401 may determine not to initiate a SL U2U Relay (re)selection request to UE-B 402 in case if there is a match in U2U Relay UE candidates between the list provided by UE-B 402 and the list maintained at UE-A 401, the number of U2U Relay UE candidates in the list provided by UE-B 402 is above a threshold there is no match in U2U Relay UE candidates between the list of UE-B 402 and the list of UE-A 401 (this implies that UE-B 402 already provided all preferable U2U Relay UE candidates and the chance for finding a new U2U Relay UE candidate matched for both UE-A 401 and UE-B 402 is rather low) or the SL UE Info from UE-B 402 includes the indication that UE-B 402 is taking a proactive action for a coordinated U2U RD.

If there is a match in U2U Relay UE candidates between the list provided by UE-B 402 and the list maintained at UE-A 401, UE-A 401 may (re)select a matched U2U Relay UE2 and initiate a new SL relay connection establishment with UE-B 402 via U2U Relay UE2. In addition, UE-A 401 may send a SL U2U Relay (re)selection indication to UE-B 402, indicating the (re)selected U2U Relay UE2 404 such as L2 ID of U2U Relay UE2 404.

If the number of U2U Relay UE candidates in the list provided by UE-B 402 is above a threshold and there is no match in U2U Relay UE candidates between the list of UE-B 402 and the list of UE-A 401, UE-A 401 may send a SL U2U Relay (re)selection indication to UE-B 402, indicating the (re)selection is currently not possible for the list provided by UE-B 402. In addition, UE-A 401 may include the list of U2U Relay UE candidates maintained at UE-A 401 in the SL U2U Relay (re)selection indication and let UE-B 402 take further action such as to perform the U2U Relay UE (re)selection including further RD if it becomes possible at UE-B 402 or to renew the SL UE Info after performing further RD as described above.

If UE-B 402 is taking a proactive action for a coordinated U2U RD, UE-A 401 may broadcast a U2U RD solicitation based on FIG. 6 with an indication indicating to U2U Relay UE candidates to skip relaying the U2U RD solicitation towards UE-B 402 but monitor the broadcast RD announcement or the groupcast RD response from UE-B 402, together with necessary configuration information for monitoring such as L2 IDs of UE-A 401 and UE-B 402.

UE-A 401 may otherwise determine to initiate a SL U2U Relay (re)selection request to UE-B 402, as follows.

Providing the request from the first user equipment to the second user equipment may comprise UE-A 401 sending the SL U2U Relay (re)selection request to UE-B 402. The request may comprise at least one of the following: a list of user equipment candidates for the further user equipment, an indication of whether coordinated discovery at the second user equipment is requested or, an indication that the first user equipment is performing the coordinated discovery procedure. The list of user equipment candidates may be a list of U2U Relay UE candidates maintained at UE-A 401 (i.e., a list of user equipment candidates for the further user equipment). The request may include an indication indicating whether a coordinated U2U RD is requested or not, depending on the number of U2U Relay UE candidates in the list. For examples, if the number of U2U Relay UE candidates in the list from UE-A 401 is above a threshold, the coordinated U2U RD may not be needed.

In response to receiving the request, the second user equipment may perform a discovery and/or (re)selection procedure for the further user equipment to act as the relay node.

The method may comprise determining, based on the request, to perform a coordinated discovery procedure at the second user equipment for the further user equipment, performing the coordinated discovery procedure and providing an indication indicating that the second user equipment is performing the coordinated discovery procedure to the first user equipment. Performing the coordinated discovery procedure comprises means for providing a broadcast discovery announcement or a groupcast discovery response to user equipment candidates, comprising layer-2 identifiers of the first user equipment and the second user equipment.

For example, if the coordinated U2U RD is requested, UE-B 402 may start announcing itself by broadcasting a RD announcement as in Model A or groupcasting a RD response as in Model B using existing L2 IDs of UE-A 401 and UE-B 402 if other L2 IDs are not configured to UE-B 402 in the request received from UE-A 401.

If the coordinated U2U RD is not requested, this may implicitly mean that UE-B 402 is allowed to perform the U2U Relay UE (re)selection and send the SL U2U Relay (re)selection indication to UE-A 401, similarly to UE-A 401 behaviors described above.

The method may comprise determining, based on the request, to perform a relay selection or relay reselection procedure, performing the relay selection or reselection procedure and providing an indication from the second user equipment to the first user equipment of an identity of the further user equipment.

The method may comprise providing an indication from the second user equipment in response to the request, wherein the indication comprises at least one of the following: an indication that selection or reselection is not currently possible based on the list of user equipment candidates or a further list of user equipment candidates for the further user equipment.

The indication may be provided in a SL U2U Relay (re)selection indication. In response to receiving the indication from the first user equipment that the first user equipment is performing the coordinated discovery procedure, the method may comprise transmitting a discovery solicitation from the second user equipment to user equipment candidates comprising an indication indicating to user equipment candidates to monitor a discovery message from the first user equipment.

In an example embodiment, UE-A 401 receives a SL U2U Relay (re)selection indication from UE-B 402 indicating at least one of the following: (i) the reselected U2U Relay UE2 404 (i.e., the further user equipment) such as L2 ID of U2U Relay UE2 404; (ii) the (re)selection is currently not possible for the list provided by UE-A 401; or (iii) UE-B 402 is performing the coordinated U2U RD (e.g., by proactively announcing itself in relation with UE1 403 via providing L2 IDs of both UE-A 401 and UE-B 402). In addition, a list of U2U Relay UE candidates maintained by UE-B 402 may be included in the SL U2U Relay (re)selection indication received from UE-B 402.

If the indication includes the reselected U2U Relay UE2 404, UE-A 401 performs SL relay connection reestablishment via the reselected U2U Relay UE.

If the indication indicates the (re)selection is not currently possible, UE-A 401 may determine to renew the SL U2U Relay (re)selection request to UE-B 402 with the request for a coordinated U2U RD or to initiate a coordinated U2U RD towards UE-B 402 without sending the request to UE-B 402 beforehand.

In response to receiving the indication at the first user equipment from the second user equipment that the second user equipment is performing the coordinated discovery procedure, the method may comprise transmitting a discovery solicitation to user equipment candidates comprising an indication indicating to user equipment candidates to monitor a discovery message from the second user equipment.

For example, if UE-B 402 is performing the coordinated U2U RD, UE-A 401 may broadcast a U2U RD solicitation based on FIG. 6 with an indication indicating to U2U Relay UE candidates to skip relaying the U2U RD solicitation towards UE-B 402 but monitor the broadcast RD announcement or the groupcast RD response from UE-B 402, together with necessary configuration information for monitoring such as L2 IDs of UE-A 401 and UE-B 402.

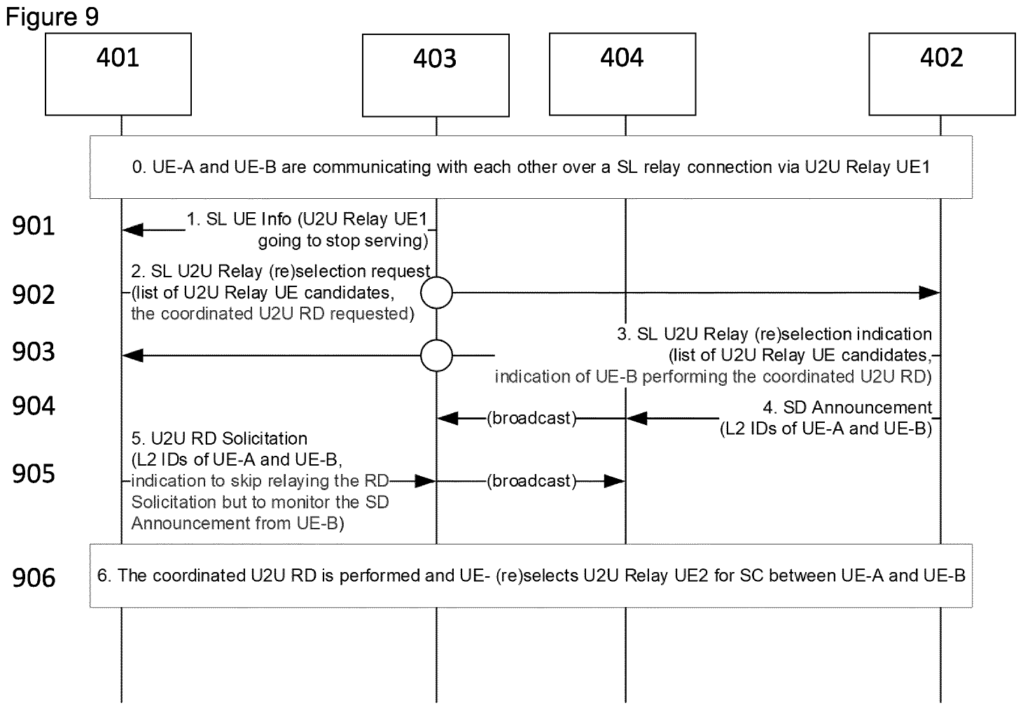

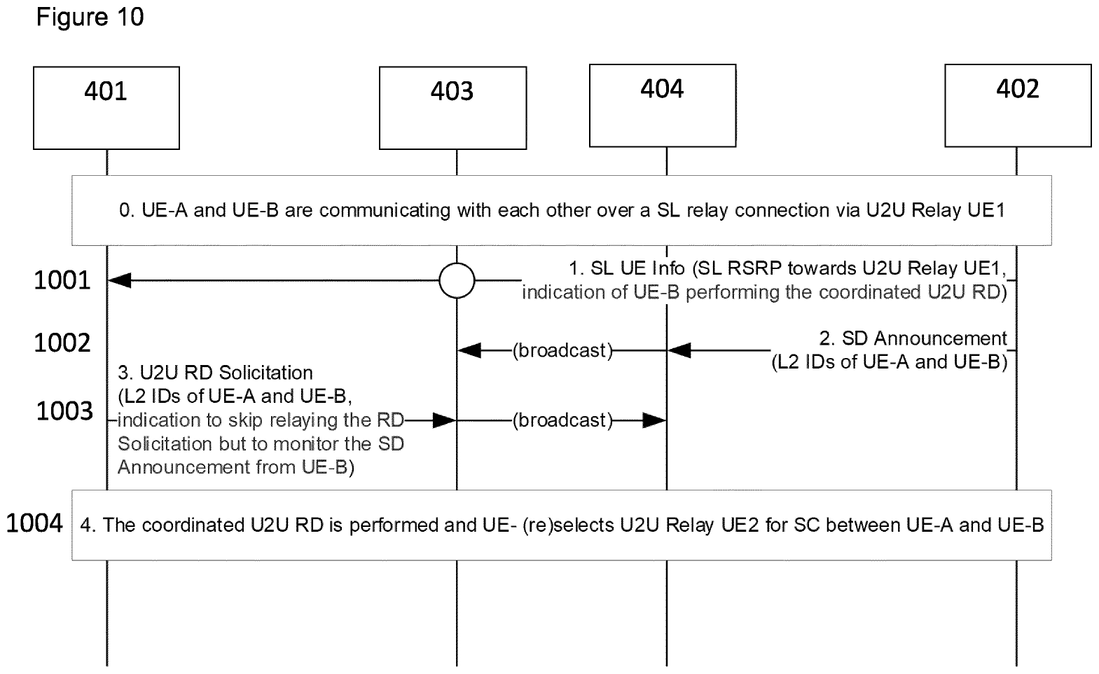

FIGS. 9 and 10 provide signalling diagrams for illustrating some features of an SL coordination procedure for U2U Relay (re)selection for SC between UE-A 401 and UE-B 402.

FIG. 9 is an example for the case where the trigger for the U2U Relay (re)selection comes from the current U2U Relay UE1 403. It is noted that 901 in FIG. 9 is not needed if UE-A 401 identifies the need for U2U Relay (re)selection by itself.

At 902, UE-A 401 sends a SL U2U relay (re)selection request including a list of U2U relay UE candidates and a request for coordinated U2U RD to UE-B 402.

At 903, UE-B 402 sends a SL U2U relay (re)selection indication including a list of U2U relay UE candidates and an indication that UE-B 402 is performing coordinated U2U RD.

At 904, UE-B 402 broadcasts a SD announcement including L2 IDs of UE-A 401 and UE-B 402.

At 905, UE-A 401 broadcasts a U2U RD solicitation including L2 IDs of UE-A and UE-B, an indication to skip relaying the RD solicitation but to monitor the SD announcement from UE-B.

At 906, the coordinated U2U RD is performed and UE-B 402 (re) selects U2U relay UE2 for SC between UE-A 401 and UE-B 402.

FIG. 10 is an example for the case where the trigger for the U2U Relay (re)selection comes from UE-B 402. In this example, UE-B 402 acts as the first user equipment and UE-A acts as the second user equipment. UE-B 402 is proactively performing the coordinated RD procedure and informs that to UE-A 401 at 1001. For example, the request comprises an indication that the first user equipment is performing a coordinated discovery procedure.

At 1002, UE-B 402 broadcasts a SD announcement including L2 IDs of UE-A 401 and UE-B 402.

At 1003, UE-A 401 broadcasts a U2U RD solicitation including L2 IDs of UE-A and UE-B, an indication to skip relaying the RD solicitation but to monitor the SD announcement from UE-B. In other words, in response to the request, the second user equipment, transmits a discovery solicitation to user equipment candidates comprising an indication indicating to user equipment candidates to monitor a discovery message from the first user equipment.

At 1004, the coordinated U2U RD is performed and UE-B 402 (re) selects U2U relay UE2 for SC between UE-A 401 and UE-B 402.

Either UE-A 401 or UE-B 402 may take the coordinating role or, in other words, initiate the SL U2U Relay (re)selection request. In this option the initiating UE (either UE-A 401 or UE-B 402) may determine to perform the coordinated U2U RD proactively and indicate that to the other UE, as described above for UE-B 402. The other UE may then act as UE-A 401 described above. That is, the initiating UE may determine to act as either UE-A 401 or UE-B 402 described above.

The trigger from the current U2U Relay UE1 403 for the U2U Relay (re)selection for SC may be sent to either UE-A 401 or UE-B 402, as determined by U2U Relay UE1 403.

SL UE Info from the current serving U2U Relay UE1 to said UE-A 401 for triggering the U2U Relay (re)selection for SC between UE-A 401 and UE-B 402 may include the cause and timing information U2U Relay UE1 403 is committed to serving UE-A 401 and UE-B 402 for performing the U2U Relay (re)selection. Based on the timing information provided by U2U Relay UE1 403, UE-A 401 may set the timing information for the coordinated U2U RD including timing information for receiving the U2U Relay (re)selection indication from UE-B 402.

The reactive SD Announcement in Step 4 of FIG. 9 or the proactive SD Announcement in Step 2 of FIG. 10 may be realized by using a specified access-stratum (AS) message broadcasted over SL by UE-B 402 (as for the examples of FIG. 5 and FIG. 6) using a default L2 DST ID specified for sidelink broadcast, instead of an actual SD announcement from upper layer. In an alternative, the specified AS message may be groupcast over SL by UE-B using L2 ID of UE-A as DST ID for the groupcast. This is based on the assumption that this is agreed with or made aware to UE-A 401 by UE-B 402 beforehand in Step 3 of FIG. 9 or in Step 1 of FIG. 10; and in turn UE-A 401 configures U2U Relay UEs to monitor the groupcast from UE-B 402 in Step 5 of FIG. 9 or in Step 3 of FIG. 10. The specified AS message may contain information such as L2 IDs of UE-A 401 and UE-B 402 so that U2U Relay UE candidates (U2U Relay UE2 404) may identify and discover UE-B 402, as requested by UE-A 401. It is noted that the use of the specified AS message above may be applied for replacing both of the options that UE-B 402 may broadcast SD Announcement using Model-A or groupcast SD Response using Model-B.

An apparatus, at a first user equipment, may comprise means for determining, based on a trigger, to select or reselect a further user equipment to act as a relay node between the first user equipment and a second user equipment, wherein the first user equipment and the second user are in communication, determining a source of the trigger, based on the determined source, determining to provide a request from the first user equipment to the second user equipment for at least one of the following: coordinated discovery of user equipment candidates for the further user equipment, selection or reselection of the further user equipment among the user equipment candidates and providing the request from the first user equipment to the second user equipment.

An apparatus, at a second user equipment, may comprise means for receiving a request from a first user equipment at the second user equipment for at least one of the following: coordinated discovery of user equipment candidates for a further user equipment, selection or reselection of the further user equipment among the user equipment candidates to act as a relay node between the first user equipment and the second user equipment, wherein the first user equipment and second user equipment are in communication.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some example embodiments have been described in relation to 5G networks, similar principles can be applied in relation to other networks and communication systems. Therefore, although certain example embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the subject disclosure.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various example embodiments may be implemented in hardware or special purpose circuitry, software, logic or any combination thereof. Some example embodiments may be implemented in hardware, while other aspects may be implemented in firmware or software which may be executed by a controller, microprocessor or other computing device, although the disclosure is not limited thereto. While various example embodiments may be illustrated and described as block diagrams, flow charts, or using some other pictorial representation, it is understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The example embodiments described herein may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Example embodiments may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various example embodiments of the disclosure is set out by the independent claims. The embodiments and features, if any, described in this specification that do not fall under the scope of the independent claims are to be interpreted as examples useful for understanding various example embodiments described herein.

The foregoing has provided by way of non-limiting examples a full and informative description of the example embodiment described herein. However, various modifications and adaptations may become apparent to those skilled in the relevant arts in view of the foregoing, when read in conjunction with the accompanying drawings and the claims. However, all such and similar modifications of the teachings of this disclosure will still fall within the scope of subject disclosure. Indeed, there is a further example embodiment comprising a combination of one or more example embodiments with any of the other example embodiments described herein.

### 1 Introduction

The revised WID on NR sidelink relay enhancements. RP-221262 include the following objective:
1. Specify mechanisms to support single-hop Layer-2 and Layer-3 UE-to-UE relay (i.e., source UE->relay UE->destination UE) for unicast [RAN2. RAN3, RAN4].
   A. Common part for Layer-2 and Layer-3 relay to be prioritized until RAN #98
      i. Relay discovery and (re)selection [RAN2. RAN+]
      ii Signalling support for Relay and remote UE authorization if SA2 concludes it is needed [RAN3]

This contribution discusses RAN2 aspects of SL U2U relays common to both L2 and L3 SL U2U relays.

### 2 Discussion

### 2.1 Scope, Requirement, or Working Assumption for Rel-18

NR SL relays including SL U2U relays are targeted for the V2X, public safety and commercial use cases, as stated in the objective of the WID RP-221262 and copied above. Hence, it is important to clarify the following aspects, related to scope, requirement, or working assumption for Rel-18.
The need to support indirect sidelink discovery (SD) with SL U2U relays: a source UE needs to discover a destination UE which is not in direct SL proximity of the source UE via one or more U2U Relay UEs.
The need to support service continuity for unicast between a source UE and a destination UE via SL U2U relay(s): this includes possible path switch from direct to indirect via a selected U2U Relay UE or from indirect to indirect via a reselected U2U Relay UE: or mode switch between L2 and L3 relays. It is noted that SL U2U relays may be used for providing SL range or coverage extension and SL RLF recovery: or enhancing QoS and energy efficiency for the source UE and the destination UE.
The need to support backward compatibility with SL U2U relays: a destination UE may be of an earlier 3GPP release and therefore not aware of SL U2U relays or, that is. SL U2U relays are transparent to the destination UE.

Proposal 1: RAN2 check and confirm with SA2 on supports for the above aspects including
a) indirect sidelink discovery.
b) service continuity and
c) backward compatibility in Rel-18 SL U2U relays.

### 2.2 SL U2U Relay Discovery

In SL U2N relays. U2N Relay UE is always associated with a serving gNB beforehand. Thus, it is enough that a Remote UE discovers a U2N Relay UE as in direct SD using either Model A or Model B. In SL U2U relays. U2U Relay UE may have no prior knowledge or association with either the source UE or the destination UE. Hence, there may be a need for coordination on the fly between the source UE, the destination UE and the U2U Relay UE in order to reassure that a U2U Relay UE candidate can reach both the source UE and the destination UE in U2U relay discovery (RD).

SA2 has so far considered a number of options related to SL U2U RD, as documented in TR 23.700-33. In one example, the source UE may issue a RD solicitation to look for U2U Relay UE candidates that may reach the destination UE, as requested by the source UE in the RD solicitation. This implies that SL U2U RD is initiated by the source UE using Model B. U2U Relay UEs in proximity of the source UE, upon receiving the RD solicitation from the source UE, may further perform SD towards the destination UE by, e.g., initiating a SD solicitation using Model B. The destination UE, upon receiving the SD solicitation from individual U2U Relay UE may respond to the individual U2U Relay UE. The individual U2U Relay UE in turn may respond to the source UE and become a U2U Relay UE candidate for the source UE. This example, however, assumes that no association between the U2U Relay UE candidate and either the source UE or the destination UE is established beforehand. In another example, it is considered that U2U Relay UE may announce a list of destination UEs that can be reached by the announcing U2U Relay UE based on using Model A. The source UE may then discover the announcing U2U Relay UE and determine whether the intended destination UE is in the list of destination UEs provided by the announcing U2U Relay UE or not. In case the determined outcome is positive, the announcing U2U Relay UE is considered as a U2U Relay UE candidate for the source UE. This example, however, assumes that association of the announcing U2U Relay UE with the list of destination UEs is established beforehand and that the source UE is restricted to the list of destination UEs provided by the announcing U2U Relay UE.

Proposal 2: RAN2 study the coordination among the source UE, the destination UE and the U2U Relay UE(s) in U2U relay discovery for L2 and L3 SL U2U based on SA2 outcome.

In SL U2N relays, both U2N Remote UE and U2N Relay UE need to meet certain radio conditions over Uu, such as DL RSRP of Remote UE below a threshold and DL RSRP of Relay UE above a threshold, beforehand. In SL U2U relays, it is so far rather open if any radio conditions need to be specified for UE acting as either the source UE, the destination UE, or the U2U Relay UE. The condition that the source UE and the destination UE are not in sufficient direct SL communication range from one to another or SL channel condition between them is below a threshold may be considered. This condition may be flexible, considering that SL U2U relays may be used for enhancing power efficiency for the source UE and the destination UE. It can be observed from the examples described above that in the first example there may be no obvious radio condition for or towards U2U Relay UE needed. In the second example, radio condition over SL between the announcing U2U Relay UE and individual destination UE in the list may be considered.

Proposal 3: RAN2 study radio conditions needed for the source UE, the destination UE, and the U2U Relay UE in SL U2U relays, considering that SL U2U relays may be used for enhancing power efficiency for the source UE and the destination UE.

It is further observed from the examples described above that the higher the number of U2U Relay UE candidates the higher the signalling overhead and associated latency are for the overall indirect SD and SL U2U RD procedures between the source UE, the destination UE and the U2U Relay UEs. This is especially costly for the destination UE if the destination UE has to respond to SD solicitations from a number of U2U Relay UE candidates individually or to announce itself to U2U Relay UEs periodically all the time.

The above issue may be eliminated by allowing the destination UE to respond to the earliest SD solicitation received from U2U Relay UE candidates using SL groupcast or broadcast or to announce itself (e.g., by starting Model B discovery) upon the need of SL U2U RD in coordination with the source UE and, consequently. U2U Relay UEs. This can be realized based on configuration information provided along the SL U2U RD procedure for example. It is noted that the source UE and the destination UE may need to provide ID information of the source UE and the destination UE to U2U Relay UEs so that U2U Relay UEs may be able to identify and validate them in SL U2U RD. In this regard. L2 IDs of the source UE and the destination UE may be provided in the configuration information.

Proposal 4: RAN2 study the use of sidelink discovery Model A and Model B in coordination between the source UE, the destination UE, and the U2U Relay UEs for SL U2U relay discovery, taking into account support for service continuity between the source UE and the destination UE.

Proposal 5: RAN2 study the use of L2 IDs of the source UE and the destination UE for fast identification of the source UE and the destination UE at U2U Relay UEs in SL U2U relay discovery.

Then due to distributed nature of SL U2U relays and uses thereof. SL traffic of SL U2U RD may be high and therefore rather power- and resource-consuming in general, even in case UEs acting as U2U Relay UEs or destination UEs do not announce themselves for SD periodically all the time.

Proposal 6: RAN2 study whether a dedicated resource pool configured for SL U2U relay discovery and SL U2U relay based indirect sidelink discovery is needed.

In many use cases, the use of SL U2U relays may be limited to members of a predefined SL group in the sense that the source UE, the destination UE, and the U2U Relay UE are members of the predefined group. For examples, in a platoon, a U2U Relay UE member may provide SL U2U relays for other UE members of the group while moving together. The same is applied for critical group communications in public safety or for personal IoT networks. In these use cases. SL U2U RD may be restricted within the group. For examples, to prevent unnecessary communications with outsiders in the above use cases. SD messages such as SD announcement or solicitation may be transmitted using SL groupcast with L2 Group ID as L2 DST ID.

Proposal 7: RAN2 study SL U2U relay discovery restricted within a predefined SL group using SL groupcast for transmitting sidelink discovery messages.

### 2.3 SL U2U Relay (Re)Selection

SL U2U relay (re)selection is expected for SL connection establishment or reestablishment between the source UE and the destination UE via a (re)selected U2U Relay UE. The SL connection establishment is triggered by the source UE. The SL connection reestablishment in the context of service continuity may be triggered by either the source UE, the destination UE, or the current serving U2U Relay UE. However, it is open which one of the source UE and the destination UE is in charge of the SL U2U relay (re)selection decision. This may also depend on how SL U2U RD is coordinated and performed between the source UE and the destination UE. For examples, some solution in TR 23.700-33 suggests that SL U2U RD may be integrated into indirect unicast SL connection establishment procedure initiated by the source UE and the destination UE may select the U2U Relay UE. In other solution in in TR 23.700-33, the source UE may discover and select the U2U Relay UE that announces or indicates to the source UE that the destination UE can be reached.

Proposal 8: RAN2 consider either the source UE or the relay UE may be in charge of SL U2U relay (re)selection.

Proposal 9: RAN2 study the coordination among the source UE, the relay UE, and the U2U Relay UEs for SL U2U relay (re)selection, considering support for service continuity between the source UE and the relay UE.

1-22. (canceled)

23. An apparatus, at a first user equipment, comprising:
at least one processor; and at least one memory storing instructions that, when executed by the at least one processor, cause the apparatus at least to perform:
determining, based on a trigger, to select or reselect a further user equipment to act as a relay node between the first user equipment and a second user equipment, wherein the first user equipment and the second user are in communication;
determining to provide a request from the first user equipment to the second user equipment for at least one of the following: selection or reselection of the further user equipment among the user equipment candidates; and
providing the request from the first user equipment to the second user equipment.

24. An apparatus according to claim 23, wherein the apparatus is further caused to perform determining a source of trigger, based on the determined source, determining to provide the request, wherein the source of the trigger is the first user equipment.

25. An apparatus according to claim 23, wherein the first user equipment and the second user equipment are in communication via a third user equipment acting as a relay node and the source of the trigger is the third user equipment acting as the relay node.

26. An apparatus according to claim 24, wherein the source of the trigger is the second user equipment, wherein the apparatus is further caused to perform: receiving information from the second user equipment and determining to provide the request for at least one of the following: coordinated discovery, selection or reselection further based on the information.

27. An apparatus according to claim 26, wherein the determining comprises determining whether the information comprises a list of user equipment candidates for the further user equipment, whether the number of user equipment candidates in the list is below a threshold, whether the list of user equipment candidates comprises a user equipment candidate on a list of user equipment candidates at the first user equipment or whether the information comprises an indication that the second user equipment is performing a coordinated relay discovery procedure.

28. An apparatus according to claim 23, wherein the request comprises at least one of the following: a list of user equipment candidates for the further user equipment, an indication of whether coordinated discovery at the second user equipment is requested or an indication that the first user equipment is performing the coordinated discovery procedure.

29. An apparatus, at a second user equipment, comprising:
at least one processor; and at least one memory storing instructions that, when executed by the at least one processor, cause the apparatus at least to perform:
receiving a request from a first user equipment at the second user equipment for at least one of the following: selection or reselection of the further user equipment among the user equipment candidates to act as a relay node between the first user equipment and the second user equipment, wherein the first user equipment and second user equipment are in communication.

30. An apparatus according to claim 29, wherein the apparatus is further caused to perform:
providing a trigger from the second user equipment to the first user equipment to select or reselect the further user equipment to act as the relay node between the first user equipment and the second user equipment.

31. An apparatus according to claim 29, wherein the request comprises a list of user equipment candidates for the further user equipment, an indication of whether coordinated discovery at the second user equipment is requested or an indication that the first user equipment is performing a coordinated discovery procedure.

32. An apparatus according to claim 31, wherein the apparatus is further caused to perform determining, based on the request, to perform a coordinated discovery procedure at the second user equipment for the further user equipment; performing the coordinated discovery procedure and providing an indication indicating that the second user equipment is performing the coordinated discovery procedure to the first user equipment.

33. An apparatus according to claim 32, wherein performing the coordinated discovery procedure comprises providing a broadcast discovery announcement or a groupcast discovery response to user equipment candidates, comprising at least one of layer-2 identifiers of the first user equipment or the second user equipment.

34. An apparatus according to claim 33, wherein the apparatus is further caused to perform determining, based on the request to perform a relay selection or relay reselection procedure at the second user equipment, performing the relay selection or reselection procedure at the second user equipment and providing an indication from the second user equipment to the first user equipment of an identity of the further user equipment.

35. An apparatus according to claim 29, wherein the apparatus is further caused to perform: providing an indication from the second user equipment in response to the request, wherein the indication comprises at least one of the following: an indication that selection or reselection is not currently possible based on the list of user equipment candidates or a further list of user equipment candidates for the further user equipment.

36. An apparatus according to claim 31, wherein the apparatus is further caused to perform: in response to receiving the indication from the first user equipment that the first user equipment is performing the coordinated discovery procedure, transmitting a discovery solicitation to user equipment candidates from the second user equipment comprising an indication indicating to user equipment candidates to monitor a discovery message from the first user equipment.

37. A method comprising, at a first user equipment:
determining, based on a trigger, to select or reselect a further user equipment to act as a relay node between the first user equipment and a second user equipment, wherein the first user equipment and the second user are in communication;
determining to provide a request from the first user equipment to the second user equipment for at least one of the following: selection or reselection of the further user equipment among the user equipment candidates; and
providing the request from the first user equipment to the second user equipment.
